(19) United States
(12) Patent Application Publication
(10) Pub. No.: US 2008/0036128 A1
(43) Pub. Date: Feb. 14, 2008

(54) Spring seat and spring assembly

(75) Inventor: Hiroshi Uehara, Hirakata-shi (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation, Neyagawa-shi (JP)

(21) Appl. No.: 11/822,646

(22) Filed: Jul. 9, 2007

(30) Foreign Application Priority Data
Aug. 8, 2006 (JP) JP 2006-215977

(51) Int. Cl. F16F 3/00; F16F 1/06; F16F 1/12

(52) U.S. Cl. 267/290; 248/580; 267/168

(57) ABSTRACT

A spring seat 51 adapted to support a large coil spring 34 to absorb and to dampen torsional vibrations and a small coil spring 35 positioned within the large coil spring 34 having a smaller outside diameter than an inside diameter of the large coil spring 34, includes a seat body 52 supporting an end of the large coil spring 34 and an end of the small coil spring 35 in a compressing direction, a first supporting portion 54 protruding from the seat body 52 in the compressing direction of the small coil spring 35 and supporting an inner periphery of the small coil spring 35, and a second supporting portion 53 formed at an end portion of the seat body to covering partial an outer periphery of the large coil spring 34 and to support an outer peripheral side of a part of the large coil spring 34.

### CROSS-REFERENCE TO RELATED APPLICATIONS

This application claims priority to Japanese Patent Application No. 2006-215977 filed on Aug. 8, 2006. The entire disclosure of Japanese Patent Application No. 2006-215977 is hereby incorporated herein by reference.

### BACKGROUND OF THE INVENTION

1. Field of the Invention

The present invention relates to a spring seat and to a spring assembly. More particularly, the present invention pertains to a spring assembly and to a spring seat adapted to the spring assembly, which is compressed in a rotating direction when at least two members of a torsional damper relatively rotate.

2. Background Information

A damper mechanism for automobiles, for example, a clutch disc assembly, a flywheel assembly, and a lockup clutch of a torque converter and the like includes a spring assembly. The spring assembly is provided so that an input rotational member and an output rotational member can be elastically engaged in a rotating direction. The spring assembly can be compressed in the rotating direction between the input rotational member and the output rotational member when the input rotational member and the output rotational member rotate relatively. As an example of such a spring assembly, a double coil spring which includes an outer coil spring and an inner coil spring is known. See Japanese Laid- Open Patent Document JP2004-183871A.

The spring assembly having the double coil springs primarily includes a large coil spring, a small coil spring, and a spring seat. The large coil spring is positioned outside of the small coil spring, and the small coil spring is positioned within the large coil spring. Spring seats are arranged at the both ends of the large coil spring and the small coil spring. In those circumstances, the large coil spring and the small coil spring are compressed simultaneously. The aforementioned construction contributes to improve spring stiffness and spring load in comparison to using a single coil spring.

According to the spring assembly having the aforementioned double coil springs, as the input rotational member and the output rotational member rotate, the small coil spring is compressed by a torsional vibration while a centrifugal force is being imposed on the spring assembly. When the small coil spring is compressed, the spring assembly is pushed radially-outwardly by the centrifugal force imposed on the spring assembly, consequently, the small coil spring may slide with an inner surface of the large coil spring. Hysteresis causes deterioration in sound vibration performance of the damper mechanism, due to friction that results in the rigid damper mechanism.

In the spring assembly described in JP2004-183871A, the hysteresis generated by sliding of the large coil spring and the small coil spring can be reduced by providing a covering portion that covers the outer periphery of the small coil spring. However, the spring assembly of the known structure may vary in performance. More particularly, with the construction of the spring assembly according to JP2004-183871A, the small coil spring is movably provided within the large coil spring in the rotating direction. Further, since a gap is provided between the large coil spring and an outside surface of the small coil spring, a position of the small coil spring within the large coil spring may not be stabilized. Consequently, the path on which the small coil spring moves may slightly vary and thus, the performance of the spring assembly may vary.

Due to the friction of the large coil spring and the small coil spring, hysteresis may be generated, which causes deterioration in sound vibration performance.

According to the spring assembly described in JP2004-183871A, when the small coil spring is compressed by torsional vibrations, the spring assembly is pushed radially-outwardly by the centrifugal force. Consequently, the large coil spring slides against an outer periphery of the window portion of each rotating member. The friction between the large coil spring and the outer periphery of the window portion causes deterioration in sound vibration performance of the damper mechanism.

A need thus exists for the present invention, which prevents the sliding of the large coil spring against the small coil spring, as well as preventing the slide of the large coil spring against the outer periphery of the window portions provided at each rotational member.

In view of the above, it will be apparent to those skilled in the art from this disclosure that there exists a need for an improved spring seat and spring assembly. This invention addresses this need in the art as well as other needs, which will become apparent to those skilled in the art from this disclosure.

### SUMMARY OF THE INVENTION

In a spring seat according to a first aspect of the present invention, the spring seat is adapted to support a large coil spring, which includes the large coil spring that absorbs and dampens torsional vibrations, a small coil spring positioned within the large coil spring having a smaller outside diameter than an inside diameter of the large coil spring, a seat body, a first supporting portion, and a second supporting portion. The seat body supports an end portion of the large coil spring and an end portion of the small coil spring in a compressing direction. The first supporting portion protrudes from the seat body in the compressing direction of the small coil spring in order to support an inner periphery of the small coil spring. The second supporting portion is formed at an end portion of the seat body to cover partially an outer periphery of the large coil spring in order partially to support an outer peripheral side of the large coil spring.

According to the aforementioned spring seat, the second supporting portion supports the large coil spring from the outer peripheral side while the first supporting portion supports the small coil spring.

With the aforementioned construction, high accuracy can be achieved by mounting the large coil spring and the small coil spring on the spring seat. High accuracy preferably refers to precisely positioning the large coil spring and the small coil spring relative to one another. Achieving high accuracy for mounting the large coil spring and the small coil spring can contribute to stability in the path the coil spring takes when compressing the small coil spring as well as reducing a variation in performance. Further, sliding movement can be prevented between the large coil spring and the small coil spring.

A spring seat according to a second aspect of the present invention is the spring seat of the first aspect, wherein the first supporting portion is tapered so that a diameter of the first supporting portion is gradually reduced in the compressing direction.

Since the diameter of the first supporting portion is gradually tapered in the compressing direction, in a process of compressing the small coil spring and the large coil spring, compression of the large coil spring and the small coil spring is unlikely to be hindered.

A spring seat according to a third aspect of the present invention is the spring seat of either one of the first or second aspects, wherein a centerline of the cylindrically formed first supporting portion and a centerline of the arc shaped second supporting portion do not overlap.

A spring assembly according to a fourth aspect of the present invention is provided at a window opening of dual rotational members for a torsional damper, and compressed in a rotating direction by the window opening when the dual rotational members relatively rotate. The spring seat includes a large coil spring, a small coil spring having smaller outside diameter than the inside diameter of the large coil spring, and the spring seat of any one of first through third aspects. The spring seat is arranged at both ends of the large coil spring and the small coil spring.

With the construction of the aforementioned spring assembly, the coil springs are compressed between the adjacent window openings formed on each of the dual rotational members when the dual rotational members relatively rotate. In those circumstances, since the spring seat is provided to the both ends of the large coil spring and the small coil spring, the large coil spring and the small coil spring are unlikely to slide.

A spring assembly according to a fifth aspect of the present inventions is the spring assembly of the fourth aspect, wherein a thickness of the second supporting portion gradually increases as a distance from the seat body increases.

With the construction of the aforementioned spring assembly, when the dual rotating members relatively rotate, the small coil spring is likely to be pushed radially-outwardly by the centrifugal force. When the dual rotating members relatively rotate, the outer periphery of the window opening and the second supporting portion slide toward each other. Consequently, the hysteresis generated by the sliding of the large coil spring and the periphery of window opening can be prevented.

A spring assembly according to a sixth aspect of the present invention is the spring assembly according to the fifth aspect, wherein the first supporting portion protrudes further in the compressing direction than an end turn portion of the small coil spring. Therefore, the small coil spring can be easily supported.

A spring assembly according to a seventh aspect of the present invention is the spring assembly of either one of the fifth aspect or sixth aspect, wherein the small coil spring is formed to have an arc shape so that both end portions of the small coil spring are in contact with an inner surface at an inner periphery side of the large coil spring in a radial direction and a center portion of the small coil spring is in contact with an inner surface at an outer periphery side of the large coil spring in the radial direction.

Due to the aforementioned arrangements, the large coil spring and the small coil spring are unlikely to slide against each other in a process of compressing of the spring assembly, while the dual rotating members rotate relatively. Therefore, wear of the large coil spring and the small coil spring can be prevented. Advantages of the invention

According to the present invention, the sliding of the large coil spring against the small coil spring can be prevented, and the sliding of the large coil spring against the outer periphery of the window openings provided to each of the rotational members can also be prevented.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross-sectional view illustrating a dual mass flywheel in accordance with a preferred embodiment of the present invention;

FIG. 2 is a front elevational view illustrating the dual mass flywheel with sections removed for illustrative purposes;

FIG. 3 is a cross-sectional view illustrating a structure of a spring assembly of the dual mass flywheel according to the preferred embodiment of the present invention;

FIG. 4 is a cross-sectional view illustrating the compressed spring assembly due to the relative rotation of an input disc plate and output disc plates of the dual mass flywheel.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents. Embodiments of a spring assembly 5 being adapted in the present invention will be explained hereinafter with reference to the attached drawings.

### Overall Configuration of a Dual Mass Flywheel

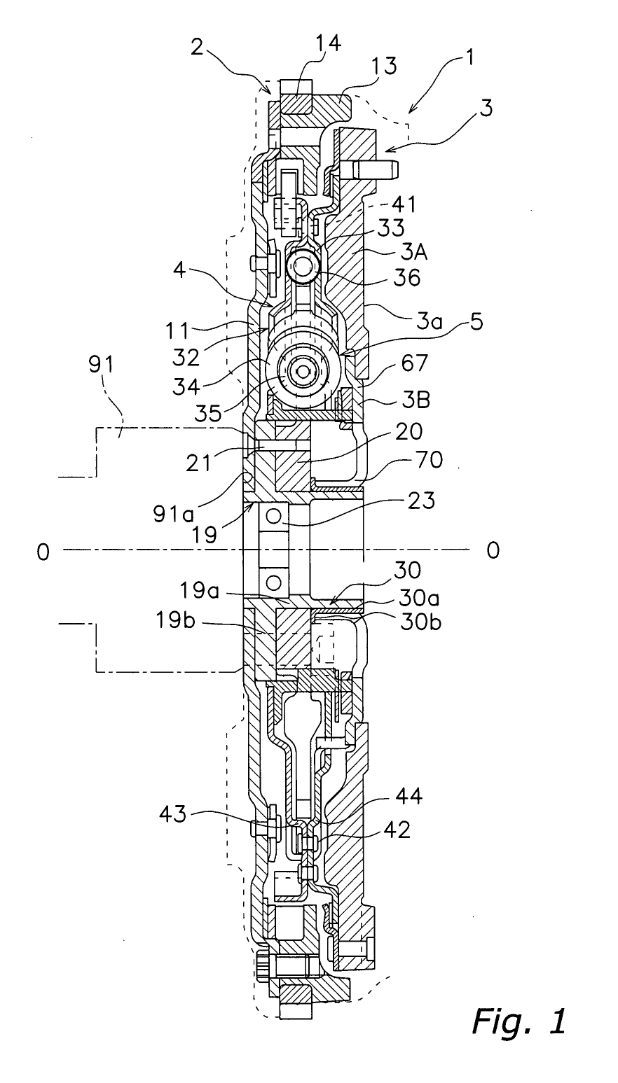

A dual mass flywheel 1 includes a spring assembly 5, which has been adapted to an embodiment of the present invention shown in FIG. 1. The dual mass flywheel 1 serves as a damper for transmitting torque from a crankshaft 91 that is provided at an engine side to an input shaft (not shown), which is provided at a transmission side through a clutch (clutch disc assembly and clutch cover assembly). The dual mass flywheel 1 primarily includes a first flywheel 2, a second flywheel 3, and a damper mechanism 4, which is provided between the both flywheels 2 and 3.

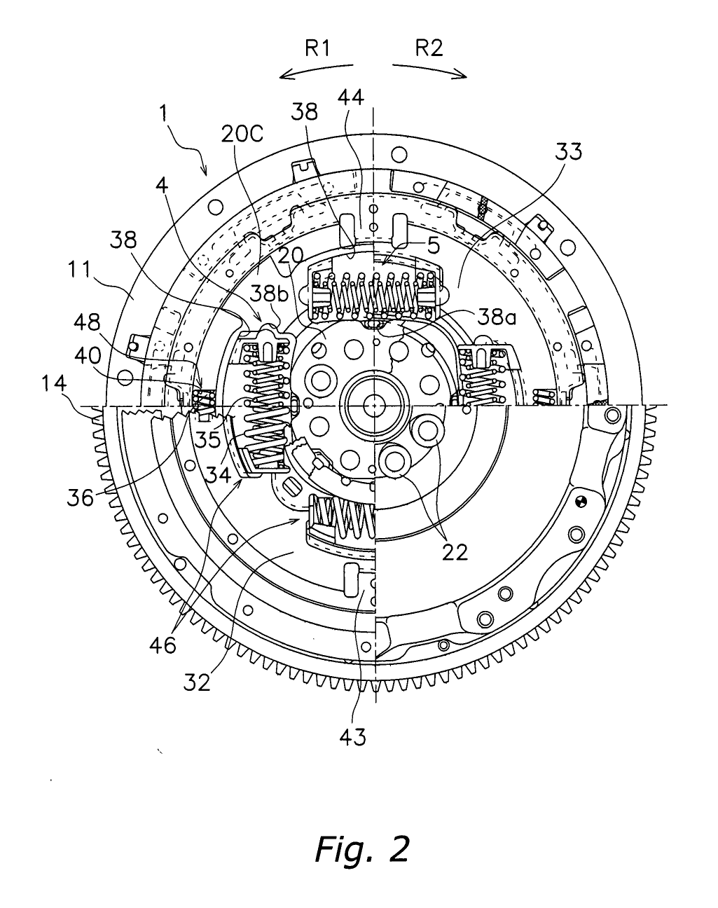

Line O-O line in FIG. 1 is a rotation axis of the dual mass flywheel 1. An engine (not shown) is provided on the left hand side of FIG. 1, and a transmission (not shown) is provided on the right hand side of FIG. 1. The left hand side is hereinafter referred to as an “axial engine side” and the right hand side is hereinafter referred to as an “axial transmission side” in FIG. 1. Further, in FIG. 2, arrow R1 points to a driving side (positive rotation direction) and arrow R2 points to a counter-driving side (negative rotation direction).

Referring to FIGS. 1 and 2, the first flywheel 2 is fixed to an end of the crankshaft 91 to supply a large inertia moment to the side of the crankshaft 91. The first flywheel 2 primarily includes a flexible plate 11 and an inertia member 13.

The flexible plate 11 is a member which transmits torque from the crankshaft 91 to the inertia member 13, while absorbing torsional vibration from the crankshaft 91. The flexible plate 11 is made to have a high stiffness in a rotating direction and a low stiffness in an axial and torsional direction. The flexible plate 11 is formed in a disc shape having a central hole. The flexible plate 11 is preferably made from sheet metal. A circular flange of the flexible plate 11 is fixed to the end of the crankshaft 91 by a plurality of bolts 22. The flexible plate 11 has corresponding through-holes for the bolts 22. The bolts 22 are preferably fixed to the crankshaft 91 from the axial direction transmission side.

The inertia member 13 is made from a thick block-like member and is being fixed at an outer periphery portion of the flexible plate 11 at an axial transmission side by rivets (not shown). An engine starter ring gear 14 is fixed at an outer periphery of the inertial member 13. Further, the first flywheel 2 may be formed by an integrally structured member.

The second flywheel 3 is an annularly shaped disc-like member, and is provided at the axial transmission side of the first flywheel 2. Further, the second flywheel 3 includes a flywheel body 3A and a positioning member 3B, which radially positions the flywheel body 3A relative to a member arranged at the side of the crankshaft.

The flywheel body 3A is a member shaped in an annular form. The thickness in the axial direction of the flywheel body 3A is preferably thicker than the thickness of the flexible plate 11. An annular and flat clutch friction surface 3a is formed on the axial transmission side. The clutch friction surface 3a is a portion where a clutch disc assembly (not shown) is connected.

The positioning member 3B is a member shaped in an annular form, preferably made of sheet metal plate. The positioning member 3B is provided at the inner periphery of the flywheel body 3A. The positioning member 3B includes an outer periphery 67, which contacts with the inner periphery of flywheel body 3A so that the positioning member 3B and the flywheel body 3A are constructed to have a concentric structure. The positioning member 3B includes a cylindrical portion 70, which further extends toward the axial engine side at an inner periphery thereof.

The damper mechanism 4 will be explained hereinafter. The damper mechanism 4 elastically engages the crankshaft 91 and the second flywheel 3 in the rotation direction. The second flywheel 3 is engaged to the crankshaft 91 through the damper mechanism 4, and thus constructs a flywheel assembly together with the damper mechanism 4. The damper mechanism 4 includes a pair of output disc plates 32 and 33, an input disc plate 20, a spring assembly 5, and a third coil spring 36.

The pair of output disc plates 32 and 33 includes a first plate 32 that is provided at an axial engine side, and a second plate 33 that is provided at the axial transmission side. Both plates 32 and 33 are disc-shaped members, which are positioned having predetermined gaps with each other in the axial direction at different inner radial positions. Circumferentially arranged plural window portions 46 are formed on each plate 32 and 33. The window portion 46 is configured to support the spring assembly 5 (described thereinafter) in an axial direction and rotating direction. The window portion 46 includes a stand-up portion, which supports the spring assembly 5 in the axial direction and contacts with both circumferential ends thereof. The window portion 46 is arranged at four circumferential positions. Further, a couple of second window portions 48 are provided at each plate 32 and 33 where the second window positions 48 are arranged at opposite positions from each other relative to the center of the each plate 32 and 33. The second window portions 48 are provided at an outer periphery of the window portions 46. The second window portions 48 support the third coil spring 36 (described hereinafter) in the axial direction and in the rotating direction.

Both outer peripheries of the first plate 32 and the second plate 33 are firmly fixed together by a plurality of rivets 41 and 42 in proximity to each other while maintaining predetermined distances between the inner peripheries of the first plate 32 and the second plate 33 in an axial direction. The first rivets 41 are circumferentially arranged. The second rivets 42 secure connecting stand-up portions 43 and 44, which are respectively formed on the first plate 32 and the second plate 33. The connecting stand-up portions 43 and 44 are provided at two respective positions, radially facing each other, more particularly, the connecting stand-up positions 43 and 44 are provided at radially outside positions of the window portions 46.

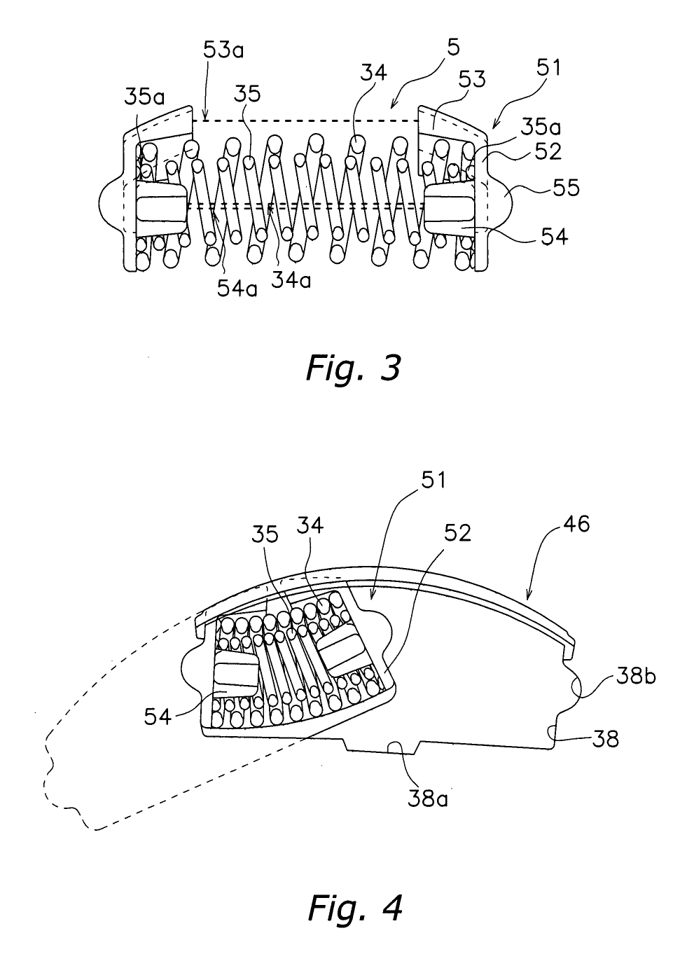

The input disc plate 20 is shaped in the form of a disc, and is provided between the output disc plates 32 and 33. Window openings 38 are formed on the input disc plate 32. The window openings 38 provided at the input disc plate 20 correspond with the window portions 46. Each window opening 38 provided at the input disc plate has a relatively linear window frame at a radially inner side. The each linear frame preferably has a notch 38a, which recesses at each center portion thereof in a rotating direction. Further, a recessed portion 38b is formed at both ends in a rotating direction of the window openings 38 provided at the input disc plate. Referring now to FIGS. 3 and 4, a convex portion 55 provided at a spring seat 51 (described thereinafter) is insertable into the recessed portion 38b. Referring again to FIGS. 1 and 2, the input disc plate 20 has a circular hole at a center thereof, and a plurality of through-holes for bolts is formed around the circular hole. Further, a plurality of projections 20C, which protrudes radially and outwardly, is formed circumferentially between each of the widow openings 38 provided at the input disc plate. The projections 20C are provided at positions away from the stand-up portions 43 and 44 of the output disc plates 32 and 33 as well as the third coil springs 36 in a rotating direction. At the same time, each projection 20C can be in contact with any of the stand-up portions 43 and 44, and the third coil spring 36 when approaching thereto. In other words, the projections 20C and the stand-up portions 43 and 44 construct a stopper mechanism for the entire damper mechanism 4. Moreover, each space formed between the projections 20C in rotating direction serves as a second window opening 40 to store the third coil spring 36.

The input disc plate 20 is fixed to the crankshaft 91 by the bolts 22, together with the flexible plate 11 and a supporting member 19. The inner periphery of the flexible plate 11 is in contact with an end surface 91 a of the crankshaft 91, on near side of a transmission in the axial direction. The supporting member 19 includes a cylindrical portion 19a and a disc-like portion 19b which extends from an outer periphery of the cylindrical portion 19a in a radial direction. The disc-like portion 19b is in contact with an end surface of the flexible plate 11 on a transmission side in the axial direction. The inner periphery of the cylindrical portion 19a is in contact with an outer peripheral surface of a columnar projection 91b which is formed at the center of an end portion of the crankshaft 91, so as to be concentric with the crankshaft. The inner periphery of the flexible plate 11 is in contact with an outer peripheral surface of the cylindrical portion 19a at an axial engine side in the axial direction so that the flexible plate 11 and the cylindrical portion 19 are constructed in a concentric manner. The inner periphery of the input disc plate 20 is in contact with an outer peripheral surface of the base portion of the cylindrical portion 19a at the transmission side in the axial direction so that the input disc plate 20 and the cylindrical portion 19a are constructed in a concentric manner. A bearing 23 is provided at the inner surface of the cylindrical portion 19a in order to support rotatably an end portion of an input shaft of the transmission. Further, the flexible plate 11, the supporting member 19, and the input disc plate 20 are firmly fixed by screws 21.

An outer periphery of the cylindrical portion 19a of the supporting member 19 supports an inner periphery of the cylindrical portion 70 of the positioning member 3B through a bush 30. Due to the aforementioned construction, the positioning member 3B is defined to be concentric with the first flywheel 2 and the crankshaft 91 by the supporting member 19. Further, the flywheel body 3A is defined concentric with the first flywheel 2 and the crankshaft 91 via the positioning member 3B. The bush 30 includes a column portion 30a, which is positioned between the cylindrical portion 70 and the cylindrical portion 19a, and a thrust portion 30b, which is positioned between the inner periphery of the input disc plate 20 and an end portion of the cylindrical portion 70 of the positioning member 3B. Due to the aforementioned construction, the thrust load of the second flywheel 3 is received by each member arranged in line with the axial direction such as the flexible plate 11, the supporting member 19, and the input disc plate 20 through the thrust portion 30b.

Spring assemblies 5 are provided in the plurality of window portions 46. Referring to FIGS. 3 and 4, each spring assembly 5 preferably includes a large coil spring 34, a small coil spring 35, and the spring seat 51.

Both ends of the large coil spring 34 extend to both ends of the window portion 46 in a rotating direction and to the window opening 38 provided in the input disc plate 20.

The small coil spring 35 is positioned within the large coil spring 34. Further, the small coil spring 35 is formed to have a moderate arc shape that extends in a radially outward direction relative to the dual mass flywheel 1. The arc is configured so that both ends of the small coil spring 35 are in contact with an inner surface of the large coil spring 34 at an inner side in a radial direction of the large coil spring 34 and the small coil spring 35, while the center portion of the small coil spring 35 is in contact with an inner surface of the center portion of the large coil spring 34 at the radially outward sides of the large coil spring 34 and the small coil spring 35 in an uncompressed state, i.e., when the springs 34 and 35 are not compressed due to relative rotation of the output disc plates 32 and 33 and the input disc plate 20. Preferably, the uncompressed state does not refer to pre-compression, i.e., compression of springs during assembly to fit into or between parts. Similar to the large coil spring 34, both ends of the small coil spring 35 extend to both ends of the window portion 46 in the rotating direction.

The spring seat 51 is provided at both ends of the large coil spring 34 and the small coil spring 35. As shown in FIG. 3, the spring seat 51 includes a supporting end portion 52, an outer periphery covering portion (second supporting portion) 53, and a projection portion (first supporting portion) 54.

The supporting end portion 52 is provided at both ends of the large coil spring 34 and the small coil spring 35, in order to support the large coil spring 34 and the small coil spring 35 in a compressing direction. Further, the supporting end portion 52 is formed in a disc shape, includes a convex portion 55 at an opposite side of a surface where the large coil spring 34 and the small coil spring 35 are provided.

The outer periphery covering portion 53 covers and supports the outer periphery of the large coil spring 34. The outer periphery covering portion 53 extends from the supporting end portion 52 to a side where the large coil spring 34 is provided. Further, the outer periphery covering portion 53 is configured to construct a partial cylinder, which is provided along the outer periphery of the large coil spring 34. Each outer periphery covering portion 53 partially covers the large coil spring 34. It should be apparent from this embodiment that the outer periphery covering portion 53 shown in FIG. 3 is preferably symmetrical. Thus, for this embodiment, partially covers with respect to the outer periphery covering portion 53 means covering at least one turn of wire in a lengthwise direction and less than half of the length, and/or approximately fifty percent or 180 degrees of the coils in the circumferential direction of the coils. However, the outer periphery covering portion 53 can cover preferably one and one half to two turns of wire in an uncompressed state and four to four and one half turns in a compressed state in the lengthwise direction, and/or fifty percent or 180 degrees of the coils in the circumferential direction of the coils. Further, as can be seen in FIGS. 3 and 4, the outer periphery covering portion 53 preferably also covers three to three and one half turns of wire of the small coil spring 35 in an uncompressed state, and four to five and one half turns of wire of the small coil spring 35 in a compressed state. As can be seen in FIGS. 3 and 4, the outer periphery covering portion 53, preferably covers the coils of the springs 34 and 35 on a radially outer side relative to the dual mass flywheel 1. A thickness of the outer periphery covering portion 53 is gradually increased from the supporting end portion 52 extending towards a side where the large coil spring and the small coil spring are provided. The outer periphery covering portion 53 has an arc shape, and is therefore an arc shaped portion.

The projection portion 54 is provided at the inner periphery of the small coil spring 35. The projection portion 54 protrudes from the supporting end portion 52 toward a side where the small coil spring 35 is provided, and thus is a column portion. The projection portion 54 is formed in an approximately cylindrical shape, and is positioned in a state where a center axis 54a of the projection portion 54 preferably overlaps a center axis of end turn portions 35a of the small coil spring 35 and the center axis 54a of the projection portion 54 is preferably eccentric with a center axis 34a of the large coil spring 34. Thus, the center axis of the end turn portions 35a is not the same as the center axis 34a. More particularly, as shown in FIG. 3, the center axis 54a of the projection portion 54 is downwardly deviated in a radial direction of the dual mass flywheel 1 from the centerline or center axis 34a of the large coil spring 34. Further, the projection portion 54 is tapered so that a diameter of the projection portion 54 is gradually reduced in the compressing direction from the supporting end portion 52. Moreover, the projection portion 54 protrudes further in the compressing direction than the end turn portion 35a (a portion made not to serve as a spring) of the small coil spring 35.

Referring now to FIGS. 1 and 2, the third coil spring 36 is provided within the second window portion 48, and is smaller than the large coil spring 34. Referring now to FIG. 1, the third coil spring 36 is provided in a radially outward position relative to the large coil spring 34 and the small coil spring 35. Further, both ends of the third coil spring 36 in the rotating direction are in contact with the both ends of the second window portion 58 in the rotating direction, while being considerably apart from both ends of the second window opening 40 in the rotating direction, that is, the end surface of the projection 20C in a rotating direction provided on the input disc plate 20.

### Movement

### 2-1. Movement to Transmit a Torque

With the construction of the dual mass flywheel 1, the torque from the crankshaft 91 of the engine is transmitted to the second flywheel 3 through the damper mechanism 4. In the damper mechanism 4, the torque is transmitted in following order: the input disc plate 20, the coil springs 34-36, and output disc plates 32 and 33. Further, the torque is transmitted from the dual mass flywheel 1 to the clutch disc assembly when the clutch is connected, and eventually, the torque is output to an input shaft (not shown) provided at the transmission side in due course.

### 2-2. Absorbing and Damping Torsional Vibration

When a combustion fluctuation from the engine is input to the dual mass flywheel 1, the input disc plate 20 and the output disc plates 32 and 33 rotate relatively within the damper mechanism 4. Between the aforementioned disc plates, the coil springs 34-36 are parallelly compressed. As shown in FIG. 4, when the coil springs 34-36 are compressed, the spring assembly 5 is consequently compressed by the input disc plate 20 and output disc plates 32 and 33. Further, as seen in FIG. 4, the portions of the coils of the large spring 34 that are in a radially outer position relative to the dual mass flywheel 1 are configured preferably to abut one another when fully compressed while the portions of the coils of the large spring 34 that are in a radially inner position relative to the dual mass flywheel 1 have space between them. The small spring 35 is similarly or identically arranged with regards to this aspect. Further, when fully compressed the outer periphery of the coils of the small spring 35 between the end turn portions 35a preferably do not contact the inner periphery of the coils of the large spring 34. More preferably, when fully compressed the outer periphery of the coils of the small spring 35 between the end turn portions 35a preferably does not contact the inner periphery of the coils of the large spring 34.

### 2-3. Advantages

Based on the aforementioned construction, contact of the large coil spring 34 and the window opening 38 provided at the input disc plate can be prevented, even when centrifugal force is imposed on the spring assembly 5 because the outer periphery covering portion 53 is formed on the spring seat 51. Therefore, wear of the large coil spring 34 due to friction between the large coil spring 34 and the window opening 38 provided at the input disc plate can be prevented. Since the projection portion 54 is provided on the spring seat 51, both ends of the small coil spring 35 can avoid being pushed toward the outer periphery of the flywheel. Further, since the small coil spring 35 is made in an arc shape, the large coil spring 34 is unlikely to contact with the center portion in a longitudinal direction of the small coil spring 35, when the spring assembly is compressed by the relative rotation of the input disc plate 20 and of the output disc plates 32 and 33. Consequently, the large coil spring 34 is unlikely to slide with the small coil spring 35 and thus wear in the large coil spring 34 and the small coil spring 35 can be prevented.

The principles and preferred embodiment of the dual mass flywheel 1, which adapts the spring assembly 5 relating to the present invention, have been described in the foregoing specification. However, the invention, which is intended to be protected is not to be constructed as limited to the particular embodiments disclosed. Variations and changes may be made by others, and equivalents employed, without departing from the scope of the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below, and transverse” as well as any other similar directional terms refer to those directions of a mechanism equipped with the present invention. Accordingly, these terms, as utilized to describe the present invention should be interpreted relative to a mechanism equipped with the present invention as normally used. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A spring seat being configured to support a large coil spring to absorb and to dampen torsional vibrations and a small coil spring being positioned within the large coil spring having a smaller outside diameter than an inside diameter of the large coil spring, comprising:
a seat body being configured to support an end portion of the large coil spring and an end portion of the small coil spring in a compressing direction;
a first supporting portion protruding from the seat body in the compressing direction inside the small coil spring and supporting an inner periphery of the small coil spring; and
a second supporting portion being formed at an end portion of the seat body to cover partially an outer periphery of the large coil spring and to support an outer peripheral side of a part of the large coil spring.

2. The spring seat according to claim 1, wherein the first supporting portion is tapered so that a diameter of the first supporting portion is reduced in the compressing direction.

3. The spring seat according to claim 2, wherein the first supporting portion includes a column portion and the second supporting portion includes an arc shaped portion, and wherein a centerline of the first supporting portion and a centerline of the second supporting portion do not overlap.

4. The spring seat according to claim 1, wherein the first supporting portion includes a column portion and the second supporting portion includes an arc shaped portion, and wherein a centerline of the first supporting portion and a centerline of the second supporting portion do not overlap.

5. A spring assembly being provided at a window opening of dual rotational members for a torsional damper, and compressed in a rotating direction by the window opening when the dual rotational members relatively rotate, comprising:
a large coil spring;
a small coil spring having a smaller outside diameter than the inside diameter of the large coil spring; and
spring seats being arranged at the both ends of the large coil spring and the small coil spring, each spring seat having
a seat body being configured to support an end portion of the large coil spring and an end portion of the small coil spring in a compressing direction,
a first supporting portion protruding from the seat body in the compressing direction inside the small coil spring and supporting an inner periphery of the small coil spring, and
a second supporting portion being formed at an end portion of the seat body to cover partially an outer periphery of the large coil spring and to support an outer peripheral side of a part of the large coil spring.

6. The spring assembly according to claim 5, wherein the first supporting portion is tapered so that a diameter of the first supporting portion is reduced in the compressing direction.

7. The spring assembly according to claim 6, wherein the first supporting portion includes a column portion and the second supporting portion includes an arc shaped portion, and wherein a centerline of the first supporting portion and a centerline of the second supporting portion do not overlap.

8. The spring assembly according to claim 5, wherein the first supporting portion includes a column portion and the second supporting portion includes an arc shaped portion, and wherein a centerline of the first supporting portion and a centerline of the second supporting portion do not overlap.

9. The spring assembly according to claim 5, wherein a thickness of the second supporting portion increases as a distance from the seat body increases.

10. The spring assembly according to claim 6, wherein the first supporting portion protrudes further in the compressing direction than an end turn portion of the small coil spring.

11. The spring assembly according to claim 6, wherein the small coil spring is formed to have an arc shape so that both end portions of the small coil spring are in contact with an inner surface at an inner periphery side of the large coil spring in a radial direction and a center portion of the small coil spring is in contact with an inner surface at an outer periphery side of the large coil spring in the radial direction.

12. The spring assembly according to claim 11, wherein an outer periphery of coils of the small coil spring does not contact the inner periphery of coils of the large coil spring when the springs are fully compressed.

13. The spring assembly according to claim 5, wherein the small coil spring is formed to have an arc shape in an uncompressed state so that both end portions of the small coil spring are in contact with an inner surface at an inner periphery side of the large coil spring in a radial direction and a center portion of the small coil spring is in contact with an inner surface at an outer periphery side of the large coil spring in the radial direction.

14. The spring assembly according to claim 13, wherein the arc extends in a radially outward direction relative to the dual rotational members.

15. The spring assembly according to claim 13, wherein an outer periphery of coils of the small coil spring does not contact the inner periphery of coils of the large coil spring when the springs are fully compressed.

16. The spring assembly according to claim 5, wherein an outer periphery of coils of the small coil spring does not contact the inner periphery of coils of the large coil spring when the springs are fully compressed.
